(19) United States
(12) Patent Application Publication
(10) Pub. No.: US 2022/0017132 A1
(43) Pub. Date: Jan. 20, 2022

(54) Rollable Hamper Assembly

(71) Applicant: Cheryl Rowland, Arvada, CO (US)

(72) Inventor: Cheryl Rowland, Arvada, CO (US)

(21) Appl. No.: 16/929,824

(22) Filed: Jul. 15, 2020

(51) Int. Cl. B62B 3/00; B62B 5/02; B62B 5/06

(52) U.S. Cl. CPC B62B 3/005; B62B 3/004; B62B 5/028; B62B 2202/66; B62B 2204/00; B62B 2202/65; B62B 5/06

(57) ABSTRACT

A rollable hamper assembly for transport of laundry and laundering supplies includes a housing having walls coupled thereto and positioned therein to define a chamber and a plurality of compartments. The chamber and compartments are used to stow articles and are accessible from an upper and rear face of the housing, respectively, which are open. An upper lid selectively closes the upper face of the housing. A pair of first rods is engaged singly to opposed sides of the housing, proximate to the rear face. The first rod comprises a plurality of nested sections and is selectively extensible. A second rod is coupled to and extends between the first rods distal from the housing. The second rod can be utilized by a user to motivate the housing upon rolling wheels, which are engaged to a bottom of the housing. The second rod can be used for hanging items.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to hamper assemblies and more particularly pertains to a new hamper assembly for transport of laundry and laundering supplies.

### (2) Description of Related Art Including Information Disclosed Under 37 CFR 1.97 and 1.98

The prior art relates to hamper assemblies. Prior art hamper assemblies may comprise a container to which a pair of wheels and a handle are engaged.

### BRIEF SUMMARY OF THE INVENTION

An embodiment of the disclosure meets the needs presented above by generally comprising a housing that defines an interior space. The housing has an upper face and a rear face, which are open. A plurality of walls is coupled to the housing and is positioned in the interior space to define a chamber and a plurality of compartments. The chamber and the compartments are configured to stow articles and are accessible from the upper face and the rear face, respectively. For example, laundry may be positioned in the chamber and other articles, such as detergent, bleach, and softener, may be stowed in the compartments. An upper lid is hingedly engaged to the housing and is positioned to selectively close the upper face of the housing.

A plurality of rolling wheels is engaged to a bottom of the housing. Each of a pair of first rods is engaged to a respective opposed side of the housing, proximate to the rear face. The first rod comprises a plurality of nested sections so that the first rod is selectively extensible. A second rod is coupled to and extends between the first rods distal from the housing. The second rod is configured to be grasped in a hand of a user to motivate the housing upon the rolling wheels. The second rod also is configured for hanging of items, such as shirts, pants, and the like, which may be positioned on a hanger prior to the hanger being hooked to the second rod.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a rollable hamper assembly according to an embodiment of the disclosure.

FIG. 2 is a front view of an embodiment of the disclosure.

FIG. 3 is a rear view of an embodiment of the disclosure.

FIG. 4 is a side view of an embodiment of the disclosure.

FIG. 5 is an in-use view of an embodiment of the disclosure.

### DETAILED DESCRIPTION OF THE INVENTION

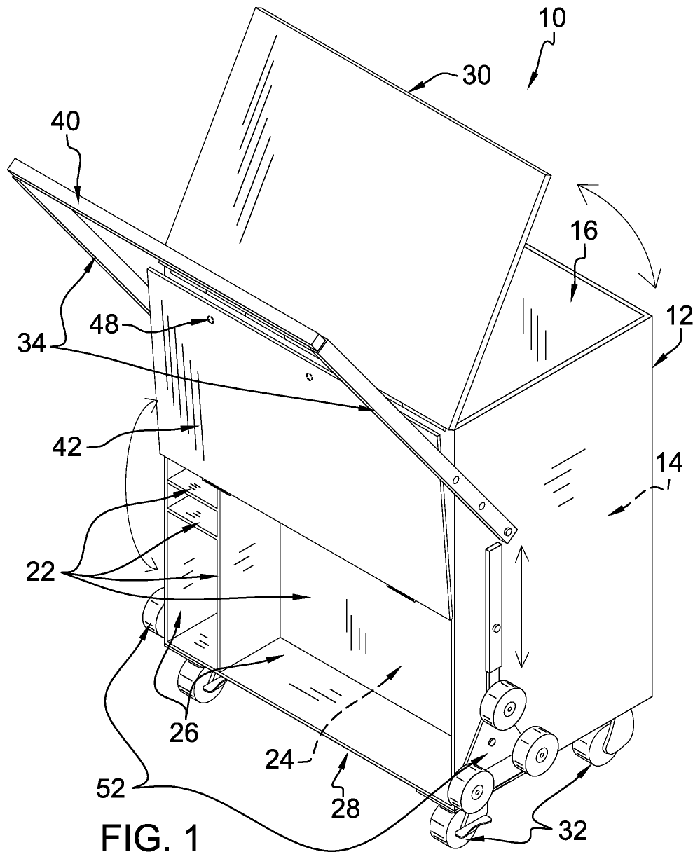

With reference now to the drawings, and in particular to FIGS. 1 through 5 thereof, a new hamper assembly embodying the principles and concepts of an embodiment of the disclosure and generally designated by the reference numeral 10 will be described.

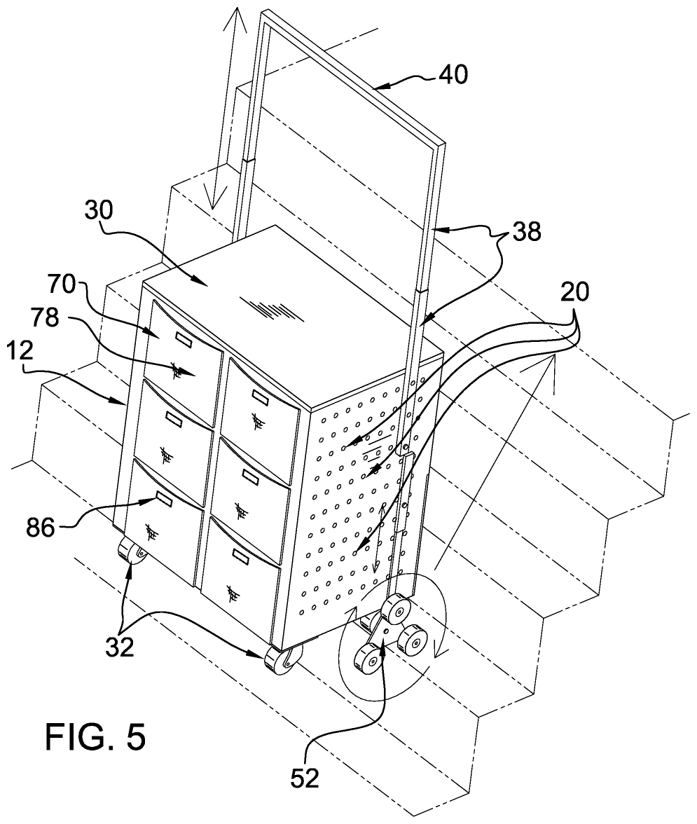

As best illustrated in FIGS. 1 through 5, the rollable hamper assembly 10 generally comprises a housing 12 that defines an interior space 14. The housing 12 has an upper face 16 and a rear face 18, which are open. The housing 12 may have a plurality of apertures 20 positioned therein, as shown in FIG. 5, which are configured to vent the interior space 14.

A plurality of walls 22 is coupled to the housing 12 and is positioned in the interior space 14 to define a chamber 24 and a plurality of compartments 26. As shown in FIG. 1, the walls 22 may be positioned proximate to a bottom 28 of the housing 12. The present invention anticipates the walls 22 being positioned proximate to the upper face 16. The present invention also anticipates the walls 22 extending from proximate to the upper face 16 to proximate to the bottom 28 of the housing 12.

The chamber 24 and the compartments 26 are configured to stow articles and are accessible from the upper face 16 and the rear face 18, respectively. For example, laundry may be positioned in the chamber 24 and other articles, such as detergent, bleach, and softener, may be stowed in the compartments 26. An upper lid 30 is hingedly engaged to the housing 12 and is positioned to selectively close the upper face 16 of the housing 12.

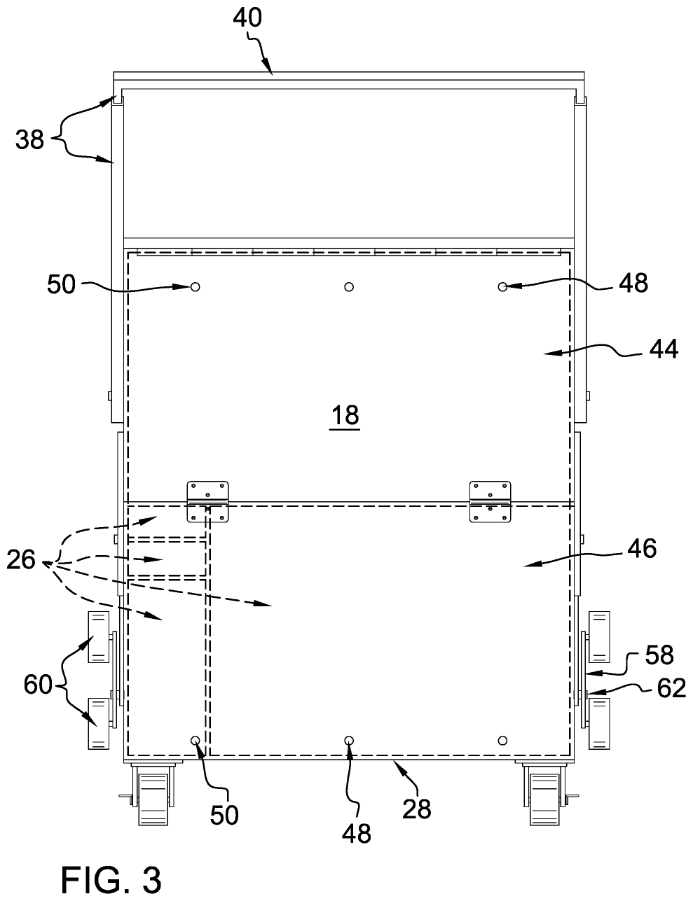

A plurality of rolling wheels 32 is engaged to the bottom 28 of the housing 12. At least one of the rolling wheels 32 is selectively lockable to prevent inadvertent movement of the housing 12 on a substantially horizontal surface. As shown in FIG. 3, the two rolling wheels 32 that are positioned proximate to the rear face 18 both are lockable.

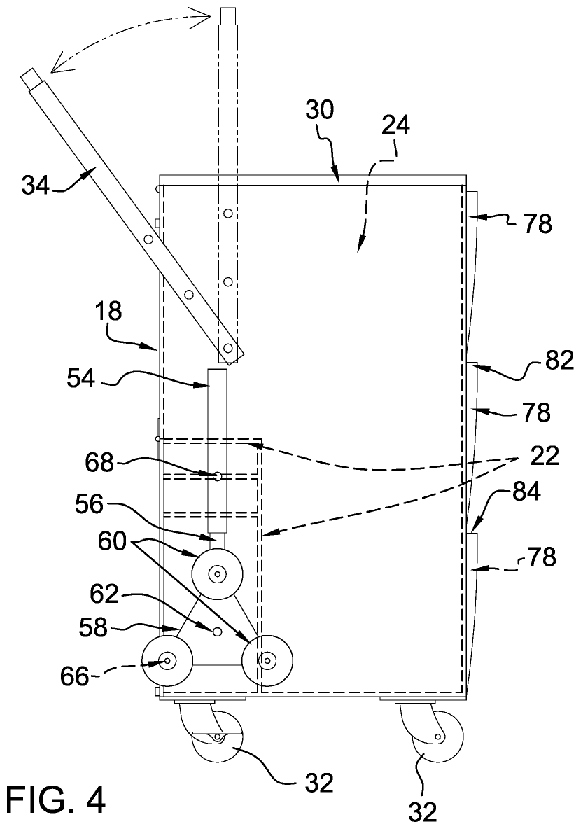

Each of a pair of first rods 34 is engaged to respective opposed side 36 of the housing 12, proximate to the rear face 18. The first rod 34 comprises a plurality of nested sections 38 so that the first rod 34 is selectively extensible, as shown in FIG. 5. The first rod 34 may be pivotally engaged to the respective opposed side 36 of the housing 12, as shown in FIG. 4.

A second rod 40 is coupled to and extends between the first rods 34 distal from the housing 12. The second rod 40 is configured to be grasped in a hand of a user to motivate the housing 12 upon the rolling wheels 32. The second rod 40 also is configured for hanging of items, such as shirts, pants, and the like, which may be positioned on a hanger (not shown) prior to the hanger being hooked to the second rod 40.

A rear lid 42 is hingedly engaged to the housing 12 and is positioned to selectively close the rear face 18 of the housing 12. As shown in FIG. 3, the rear lid 42 may comprise an upper section 44 and a lower section 46. The upper section 44 is configured to be hinged downwardly to access the interior space 14 proximate to the upper face 16. The lower section 46 is configured to be hinged upwardly to access the interior space 14 proximate to the bottom 28 of the housing 12.

A lid fastener 48 is engaged to the rear lid 42 and is selectively engageable to the housing 12 to fixedly position the rear lid 42 over the rear face 18 of the housing 12. The lid fastener 48 may comprise a magnet 50, or other fastening means, such as, but not limited to, latches, camlocks, and the like.

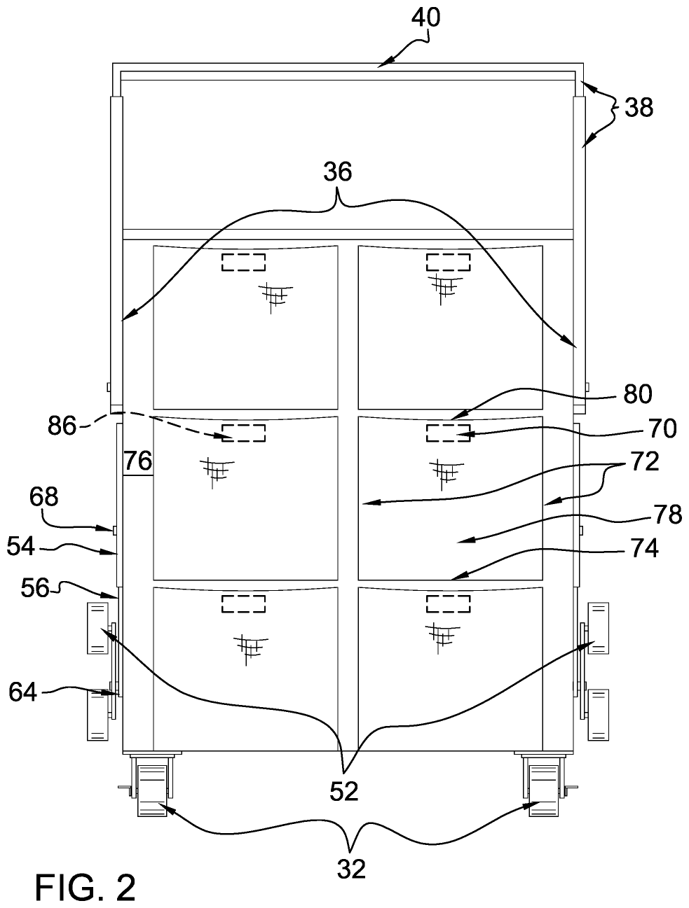

Each of a pair of climbing units 52 is engaged to a respective opposed side 36 of the housing 12, proximate to the rear face 18, as shown in FIG. 2. The pair of climbing units 52 is configured to facilitate transitioning of the housing 12 from one to the next of a set of stairsteps, as shown in FIG. 5.

Each climbing unit 52 comprises a tube 54, a bar 56, a plate 58, and a set of climbing wheels 60. The tube 54 is coupled to the respective opposed side 36 of the housing 12. The bar 56 is positioned in and is selectively extensible from the tube 54. The plate 58 has a centerpoint 62, which is rotationally engaged to a terminus 64 of the bar 56, as shown in FIG. 4. The plate 58 may be equilateral triangle shaped, or alternatively shaped, such as squarely shaped, pentagonally shaped, and the like. Each climbing wheel 60 is rotationally engaged to the plate 58 proximate to a respective corner 66 of the plate 58. An actuator 68 is engaged to the bar 56 and the tube 54 and is positioned to selectively actuate the bar 56 to extend the bar 56 from the tube 54.

With the bar 56 extended from the tube 54, the centerpoint 62 of the plate 58 is positioned below the bottom 28 of the housing 12, as shown in FIG. 5. The plate 58 being rotatable relative to the bar 56, and the climbing wheels 60 be rotatable relative to the plate 58, facilitate the transitioning of the housing 12 from one to the next of a set of stairsteps.

The assembly 10 also comprises a panel 70, which has opposing side edges 72 and a lower edge 74 that are coupled to a front face 76 of the housing 12 to define a pocket 78. The pocket 78 can be used to stow items of use to the user, such as laundry related items. As shown in FIG. 2, more than one panel 70 may be coupled to the front face 76.

A closure 80 is engaged to an upper edge 82 of the panel 70 and is selectively engageable to the front face 76 of the housing 12 to close an opening 84 of the pocket 78. The closure 80 may comprise a hook and loop fastener 86, or other closing means, such as, but not limited to, buttons, zippers, and the like.

In use, soiled laundry is positioned in the chamber 24. The housing 12 may be positioned in a closet, or the like, and the soiled laundry added to the chamber 24 as it is generated. The user then is positioned to transport the housing 12, utilizing the rolling wheels 32 and the climbing wheels 60, when required, to a laundering facility. The compartments 26 and pockets 78 are available to stow miscellaneous laundry accessories. The first rods 34 can be extended and pivoted to so that the second rod 40 is positioned above and parallel to the upper face 16 of the housing 12, allowing it to be used to hang items of clothing. Upon completion of laundering, the chamber 24 can be used to stow the clean laundry for a return trip.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

1. A rollable hamper assembly comprising:
a housing defining an interior space, the housing having an upper face and a rear face, the upper face and the rear face being open;
a plurality of walls coupled to the housing and positioned in the interior space defining a chamber, accessible from the upper face, and a plurality of compartments, accessible from the rear face, wherein the chamber and the compartments are configured for stowing articles;
an upper lid hingedly engaged to the housing such that the upper lid is positioned for selectively closing the upper face of the housing;
a plurality of rolling wheels engaged to a bottom of the housing;
a pair of first rods, each first rod being engaged to respective opposed side of the housing proximate to the rear face, the first rod comprising a plurality of nested sections such that the first rod is selectively extensible;
a second rod coupled to and extending between the first rods distal from the housing, wherein the second rod is configured for grasping in a hand of a user for motivating the housing upon the rolling wheels, and wherein the second rod is configured for hanging of items; and
a rear lid hingedly engaged to the housing such that the rear lid is positioned for selectively closing the rear face of the housing, wherein the rear lid comprises an upper section configured for hinging downwardly, for accessing the interior space proximate to the upper face, and a lower section configured for hinging upwardly, for accessing the interior space proximate to the bottom of the housing.

2. The rollable hamper assembly of claim 1, wherein at least one of the rolling wheels is selectively lockable for preventing inadvertent movement of the housing on a horizontal surface.

3. (canceled)

4. (canceled)

5. The rollable hamper assembly of claim 1, further including a lid fastener engaged to the rear lid and selectively engageable to the housing for fixedly positioning the rear lid over the rear face of the housing.

6. The rollable hamper assembly of claim 5, wherein the lid fastener comprises a magnet.

7. The rollable hamper assembly of claim 1, wherein the first rod is pivotally engaged to the respective opposed side of the housing;

8. The rollable hamper assembly of claim 1, wherein the housing has a plurality of apertures positioned therein, wherein the apertures are configured for venting the interior space.

9. The rollable hamper assembly of claim 1, further including a pair of climbing units, each climbing unit being engaged to a respective opposed side of the housing proximate to the rear face and being configured to facilitate transitioning of the housing from one to the next of a set of stairsteps.

10. The rollable hamper assembly of claim 9, wherein the climbing unit comprises:
a tube coupled to the respective opposed side of the housing;
a bar positioned in and selectively extensible from the tube;
a plate having a centerpoint rotationally engaged to a terminus of the bar; and
a set of climbing wheels, each climbing wheel being rotationally engaged to the plate proximate to a respective corner of the plate.

11. The rollable hamper assembly of claim 10, wherein the plate is equilateral triangle shaped.

12. The rollable hamper assembly of claim 10, further including an actuator engaged to the bar and the tube such that the actuator is positioned for selectively actuating the bar for extending from the tube, such that the centerpoint of the plate is positioned below the bottom of the housing.

13. The rollable hamper assembly of claim 1, further including a panel having opposing side edges and a lower edge coupled to a front face of the housing defining a pocket.

14. The rollable hamper assembly of claim 13, further including a closure engaged to an upper edge of the panel and selectively engageable to the front face of the housing for closing an opening of the pocket.

15. The rollable hamper assembly of claim 14, wherein the closure comprises a hook and loop fastener.

16. A rollable hamper assembly comprising:
a housing defining an interior space, the housing having an upper face and a rear face, the upper face and the rear face being open, the housing having a plurality of apertures positioned therein, wherein the apertures are configured for venting the interior space;
a plurality of walls coupled to the housing and positioned in the interior space defining a chamber, accessible from the upper face, and a plurality of compartments accessible from the rear face, wherein the chamber and the compartments are configured for stowing articles;
an upper lid hingedly engaged to the housing such that the upper lid is positioned for selectively closing the upper face of the housing;
a plurality of rolling wheels engaged to a bottom of the housing, at least one of the rolling wheels being selectively lockable for preventing inadvertent movement of the housing on a horizontal surface;
a rear lid hingedly engaged to the housing such that the rear lid is positioned for selectively closing the rear face of the housing, the rear lid comprising an upper section configured for hinging downwardly, for accessing the interior space proximate to the upper face, and a lower section configured for hinging upwardly for accessing the interior space proximate to the bottom of the housing;
a lid fastener engaged to the rear lid and selectively engageable to the housing for fixedly positioning the rear lid over the rear face of the housing, the lid fastener comprising a magnet;
a pair of first rods, each first rod being engaged to respective opposed side of the housing proximate to the rear face, the first rod comprising a plurality of nested sections such that the first rod is selectively extensible, the first rod being pivotally engaged to the respective opposed side of the housing;
a second rod coupled to and extending between the first rods distal from the housing, wherein the second rod is configured for grasping in a hand of a user for motivating the housing upon the rolling wheels, and wherein the second rod is configured for hanging of items;
a plurality of apertures positioned in the housing wherein the apertures are configured for venting the interior space;
a pair of climbing units, each climbing unit being engaged to a respective opposed side of the housing proximate to the rear face and being configured to facilitate transitioning of the housing from one to the next of a set of stairsteps, the climbing unit comprising:
a tube coupled to the respective opposed side of the housing,
a bar positioned in and selectively extensible from the tube,
a plate having a centerpoint rotationally engaged to a terminus of the bar, the plate being equilateral triangle shaped,
a set of climbing wheels, each climbing wheel being rotationally engaged to the plate proximate to a respective corner of the plate, and
an actuator engaged to the bar and the tube such that the actuator is positioned for selectively actuating the bar for extending from the tube, such that the centerpoint of the plate is positioned below the bottom of the housing;
a panel having opposing side edges and a lower edge coupled to a front face of the housing defining a pocket; and
a closure engaged to an upper edge of the panel and selectively engageable to the front face of the housing for closing an opening of the pocket, the closure comprising a hook and loop fastener.
